(19) United States
(12) Patent Application Publication
(10) Pub. No.: US 2001/0015611 A1
(43) Pub. Date: Aug. 23, 2001

(54) Electrode of electron gun for CRT

(76) Inventor: Kwang-ki Sung, Kyungsangnam-do (KR)

Correspondence Address: LEYDIG VOIT & MAYER, LTD, 700 THIRTEENTH ST. NW, SUITE 300, WASHINGTON, DC, 20005-3960, US

(21) Appl. No.: 09/771,978

(22) Filed: Jan. 30, 2001

(30) Foreign Application Priority Data
Feb. 17, 2000 (KR) 2000-7521

(51) Int. Cl. H01J 29/50

(52) U.S. Cl. 313/417; 313/414

(57) ABSTRACT

An electrode of an electron gun for a CRT includes an electron beam passing surface at which electron beam passing holes are formed, a skirt portion extending from an edge of the electron beam passing surface substantially perpendicularly with respect to the electron beam passing surface, a plurality of first embedded portions extending from an end portion of each of the upper and lower sides of the skirt portion and embedded in bead glass, and a second embedded portion formed by cutting a portion of the skirt portion and bending the cut portion and embedded in the bead glass.

### BACKGROUND OF THE INVENTION

1. Field of the Invention

The present invention relates to an electron gun for cathode ray tube (CRT), and more particularly, to an electrode of an electron gun for a CRT forming an electron lens.

2. Description of the Related Art

A CRT includes a panel on which a fluorescent film is formed, a funnel coupled to the panel, a shadow mask installed inside the panel and having plurality of electron beam passing holes formed thereon, and a deflection yoke installed at a cone portion of the funnel.

FIG. 1 shows a typical electron gun installed in a neck portion of a funnel of a CRT. Referring to the drawing, an electron gun for a CRT includes a cathode 31 which forms an source for emitting an electron beam to excite a fluorescent film (not shown), a control electrode 32, a screen electrode 33, a plurality of focus electrodes 34 through 37 forming an auxiliary lens, and a final acceleration electrode 38 forming a main lens, which are all installed at the neck portion 12 of a funnel of a CRT.

Three cathodes 31 are arranged in-line as thermion emitting sources. The control electrode 32 and the screen electrode 33 for controlling the amount of electrons emitted from the cathode 31 are installed corresponding to the cathodes 31.

The focus electrodes 34 through 37 are sequentially installed corresponding to the screen electrode 32 to form focus lenses. The final acceleration electrode 38 is installed corresponding to the focus electrodes 34 through 37 to form a main lens. Three electron beam passing holes aligned are formed in-line so as to pass three electron beams at each of the electrodes. Bead glass 16 is welded to both sides of the electrodes, so that the electrodes are fixed to each other.

FIG. 2 is a perspective view showing one of the electrodes separated from the electron gun of FIG. 1. Referring to the drawing, an electrode 20 includes an electron beam passing surface 22 at which three electron beam passing holes RH, GH and BH are formed in-line, a skirt portion 21 perpendicularly extending from the edge of the electron beam passing surface 22, a rim 23 perpendicularly extending from the edge of the skirt portion 22 to encircle the skirt portion 21, and embedded portions 24 formed at sides of the rim 23 to be embedded in the bead glass 16 (see FIG. 1).

The electrode 20 having the above structure is embedded in the bead glass 16 and fixed thereto by a bead glass welder (not shown). In the process of welding the bead glass 16, the respective electrodes are aligned on a mandrel of a jig while the respective electrodes forming the electron gun are maintained at particular intervals. Next, the heated bead glass is pressed toward the embedded portions 24 of each of the electrodes from both sides of the jig holding the electrodes. Then, the embedded portions 24 of each of the electrodes is embedded in the semi-melt bead glass 16 and is fixed when the bead glass 16 is solidified.

However, since the electrodes are fixed by means of the embedded portions 24 only one of which is formed at each of the upper and lower side of the rim 23, respectively, the support intensity of the bead glass is not sufficient so that defective alignment can be generated. Also, since the electrodes may be fixed to the bead glass in a defective alignment state, although a convergence means (not shown) or a focusing means (not shown) is provided, a displayed image may be blur or unclear, thus lowering the resolution of the CRT.

Further, when an error is generated at the interval between the electrodes with respect to the bead glass, fine cracks can be generated at the bead glass. Also, as the width w of the skirt portion 21 increases, the above problems become serious.

### SUMMARY OF THE INVENTION

To solve the above problems, it is an object of the present invention to provide an electrode of an electron gun for a CRT which can be accurately aligned and stably fixed to the bead glass.

Accordingly, to achieve the above object, there is provided an electrode of an electron gun for a CRT includes an electron beam passing surface at which electron beam passing holes are formed, a skirt portion extending from an edge of the electron beam passing surface substantially perpendicularly with respect to the electron beam passing surface, a plurality of first embedded portions extending from an end portion of each of the upper and lower sides of the skirt portion and embedded in bead glass, and a second embedded portion formed by cutting a portion of the skirt portion and bending the cut portion and embedded in the bead glass.

It is preferred in the present invention that at least one second embedded portion is formed at each of the upper and lower sides of the skirt portion, and that at least two first embedded portions are formed at each of the upper and lower sides of the end portion of the skirt portion.

Also, it is preferred in the present invention that a hole is formed in a portion of the first embedded portion which is embedded in the bead glass, an opening is formed in a portion of the first embedded portion which is embedded in the bead glass, and a protrusion is formed at a portion of the first embedded portion which is embedded in the bead glass.

Also, it is preferred in the present invention that a hole is formed in a portion of the second embedded portion which is embedded in the bead glass, an opening is formed in a portion of the second embedded portion which is embedded in the bead glass, and a protrusion is formed at a portion of the second embedded portion which is embedded in the bead glass.

Also, it is preferred in the present invention that the width of the skirt is equal to or more than 4.5 mm.

### BRIEF DESCRIPTION OF THE DRAWINGS

The above object and advantages of the present invention will become more apparent by describing in detail preferred embodiments thereof with reference to the attached drawings in which:

FIG. 1 is a sectional view of a portion of a typical CRT including an electrode of an electron gun;

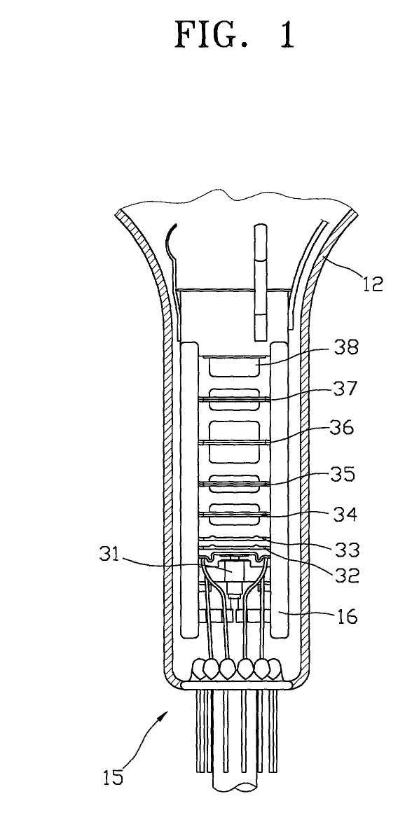

FIG. 2 is a perspective view showing a typical electrode of an electron gun;

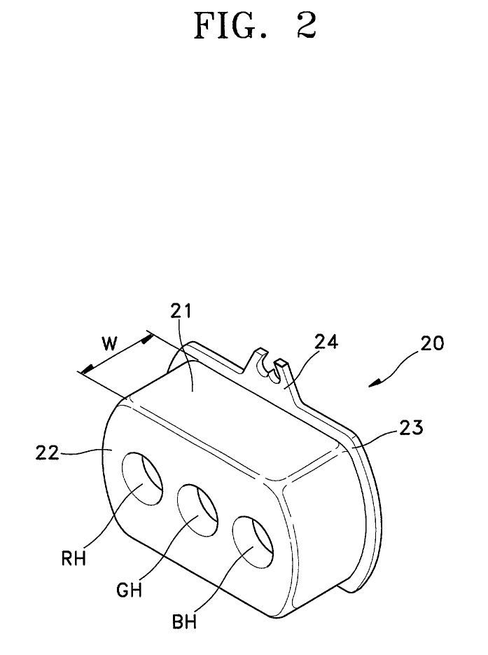

FIG. 3A is an exploded perspective view showing an electrode and the bead glass of an electron gun according to a preferred embodiment of the present invention;

FIG. 3B is a sectional view of the electrode and the bead glass of FIG. 3A;

FIG. 4 is a perspective view showing an electrode of an electron gun for a CRT according to another preferred embodiment of the present invention; and

FIGS. 5 and 6 are perspective views showing electrodes of an electron gun for a CRT according to other preferred embodiments of the present invention.

### DETAILED DESCRIPTION OF THE INVENTION

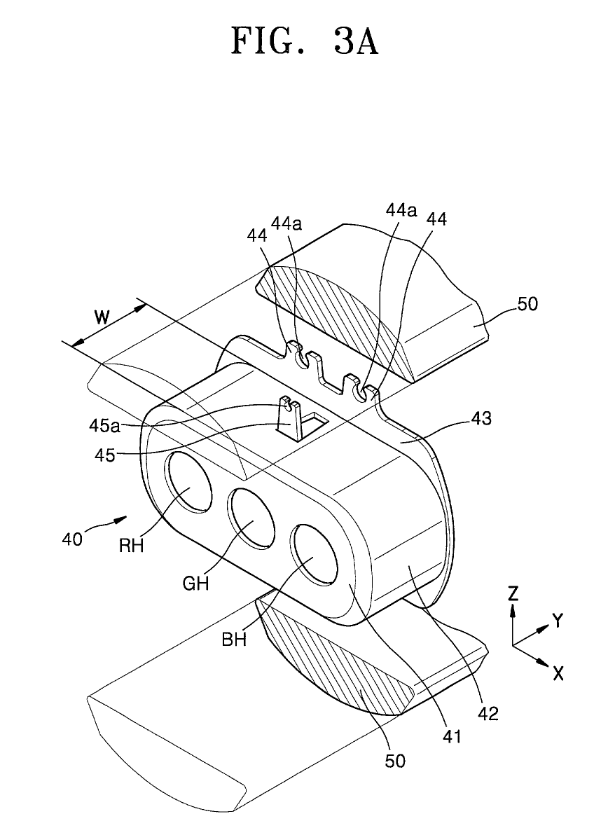

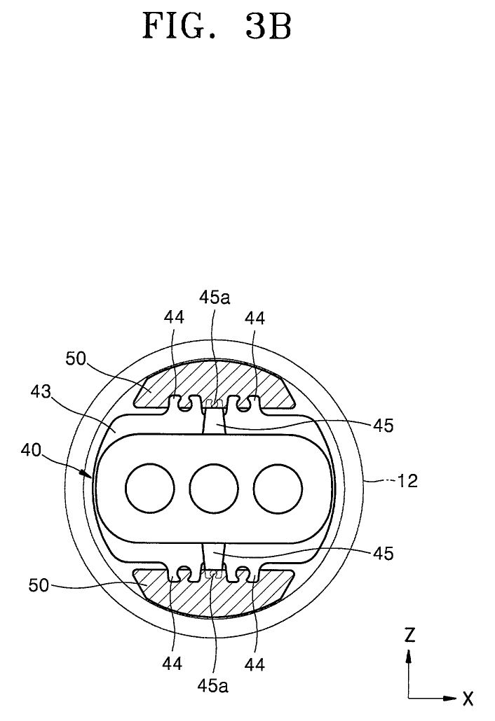

In the specification and claims of the present invention, X, Y and Z axes are shown as shown in FIG. 3A for convenience of explanation. Here, Y axis shows a direction of an electron beam. The direction indicated by an arrow in the Z direction is the “upper” side while the opposite direction is the “lower” side. The direction indicated by an arrow in the Y direction is the “front” side while the opposite direction is the “rear” side. The direction indicated by an arrow in the X direction is the “right” side while the opposite direction is the “left” side. In FIG. 3B, reference numeral 12 denotes a neck portion of a funnel.

Referring to FIG. 3A, an electrode 40 includes an electron beam passing surface 41 at which three electron beam passing holes RH, GH and BH are formed in-line, a skirt portion 42 perpendicularly extending a predetermined width w from the edge of the electron beam passing surface 41, a rim 43 perpendicularly extending from an end portion of the skirt portion 42 to encircle the skirt portion 42, and first embedded portions 44 formed at the rim 43 to extend in the upper and lower side directions. The first embedded portions 44 are embedded in bead glass 50.

Although the first embedded portions 44 are formed at each of the upper and lower sides of the electrode 40 along the rim 43 at a predetermined interval, the present invention does not limited thereto. That is, the embedded portions 44 can be formed at the rim 43 to the right or left according to the position of the bead glass 50 in which the embedded portions 44 are embedded. Also, a single first embedded portion can be formed instead of two embedded portions. Further, the first embedded portion 44 can be formed directly at the end portion of the skirt portion 42 in the state in which the rim 43 is removed.

An opening 44a is formed at each of the first embedded portions 44 so that the electrode 40 can be firmly fixed to the bead glass 50 when it is embedded into the bead glass 50. Preferably, the opening 44a has a shape enabling a firm fixing and supporting of the electrode 40. Also, for the firm fixing and supporting of the electrode 40, a hole (not shown) having a predetermined shape can be formed at the first embedded portion 44 or a protrusion (not shown) having a predetermined shape can be provided.

When the width w of the skirt portion 42 increases, in particularly, to 4.5 mm or more, the fixing and supporting of the electrode 40 is unstable and alignment of the electrode 40 is defective. To prevent the above defectiveness, a second embedded portion 45 is formed at the skirt portion 42.

The second embedded portion 45 is formed by cutting a portion of the skirt portion 42 off and bending in one direction so that it can be embedded in the bead glass 50. An opening or protrusion with predetermined shape can be formed at the second embedded portion 45.

In the preferred embodiment shown in FIG. 3A, the second embedded portion 45 is formed on the skirt portion 42 at a position separated a predetermined distance toward the read side from the center position between the first embedded portions 44. The second embedded portion 45 is formed by cutting a portion of the skirt portion 42 off and bending the same toward the read side. Also, the second embedded portion 45 is formed at each of the upper and lower sides of the electrode 40 so that the second embedded portion 45 can be embedded in each of the upper and lower bead glass 50. Here, the second embedded portions 45 are preferably formed at each of the upper and lower sides of the electrode 40 to correspond to each other. Preferably, an opening 45a is formed at the second embedded portion 45 so that the second embedded portion 45 can be firmly fixed to the beam glass 50. The state in which the first embedded portion 44 and the second embedded portion 45 are embedded in the bead glass 50 is shown in FIG. 3B.

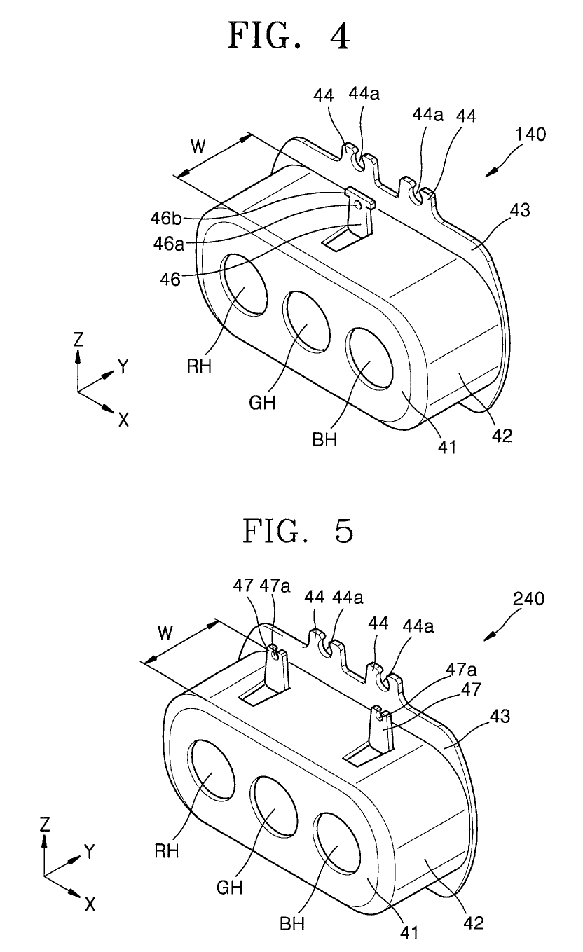

Referring to FIG. 4, an electrode of an electron gun according to another preferred embodiment of the present invention has a similar shape as a whole to the electrode 40 shown in FIG. 3A. However, it is distinguished that a second embedded portion 46 is formed by cutting a portion of the skirt portion 42 and bending the same toward the front side. Also, a hole 46a and a protrusion 46b are formed at the second embedded portion 46, unlike the embodiment of FIG. 3A.

The opening 45a, the hole 46a or the protrusion 46b formed at the second embedded portions 45 and 46 may have any shapes only if the opening 45a, the hole 46a or the protrusion 46b enable firm fixing and supporting of the electrode 40 when they are embedded in the bead glass 50. In the structure of the electrode shown in FIGS. 3A, 3B and 4, when the first and second embedded portions 45 and 46 are embedded in the bead glass 50, since three points support is made possible at each of the upper and lower sides of the electrode, the electrode can be fixed more firmly and reliably.

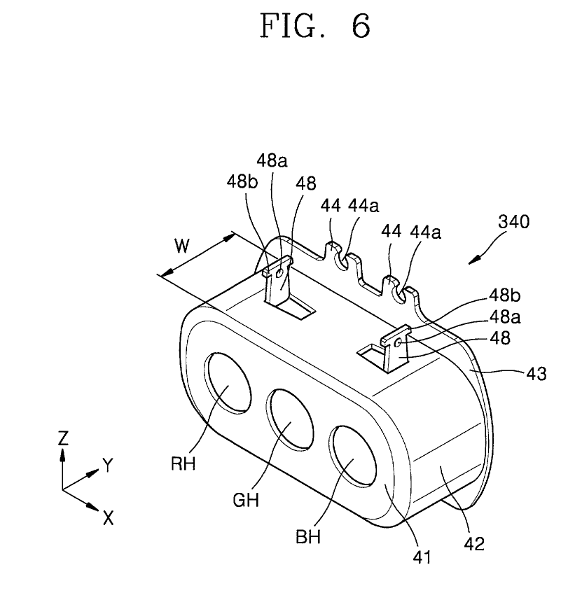

FIGS. 5 and 6 show electrodes according to other preferred embodiment of the present invention. In the drawings, the same reference numerals indicate the same elements having the same functions.

Referring to FIG. 5, a pair of second embedded portions 47 are formed at each of the upper and lower sides of the skirt portion 42 and are embedded in bead glass.

The second embedded portions 47 are formed at the skirt portion 42 separated a predetermined distance from each of the first embedded portion 44. Each of the second embedded portions 47 is formed by cutting a portion of the skirt portion 42 and bending the same toward the front side. In another embodiment which is not shown, the two second embedding portions 47 can be formed by cutting the skirt portion 42 and bending the same toward the rear side. An opening 47a is formed at each of the second embedding portions 47.

Referring to FIG. 6, a pair of second embedded portions 48 are formed at each of the upper and lower sides of the skirt portion 42 by cutting portions of the skirt portion 42 and bending the same in the opposite directions along the X axis. Also, the hole 48a and the protrusion portion 48b are formed at each of the second embedded portions 48.

The opening 47a, the hole 48a or the protrusion 48b formed at the second embedded portions 47 and 48 may have any shapes only if the opening 47a, the hole 48a or the protrusion 48b enable firm fixing and supporting of the electrode 40 when they are embedded in the bead glass 50.

In the structure of the electrode shown in FIGS. 5 and 6, when the first and second embedded portions 44, 47 and 48 are embedded in the bead glass 50, since four points support is made possible at each of the upper and lower sides of the electrode, the electrode can be fixed more firmly and reliably.

As described above, in the electrode of an electron gun for a CRT according to the present invention, not only at least one first embedded portion is formed at the rim as an embedded portion, but also at least one second embedded portion is formed at the skirt portion, as a portion embedded in the bead glass to fix the electrode. Thus, the electrode embedded in the bead glass is supported at three or four points so that the electrode can be aligned firmly and reliably.

It is noted that the present invention is not limited to the preferred embodiment described above, and it is apparent that variations and modifications by those skilled in the art can be effected within the spirit and scope of the present invention defined in the appended claims.

What is claimed is:

1. An electrode of an electron gun for a CRT comprising:
an electron beam passing surface at which electron beam passing holes are formed;
a skirt portion extending from an edge of the electron beam passing surface substantially perpendicularly with respect to the electron beam passing surface;
a plurality of first embedded portions extending from an end portion of each of the upper and lower sides of the skirt portion and embedded in bead glass; and
a second embedded portion formed by cutting a portion of the skirt portion and bending the cut portion and embedded in the bead glass.

2. The electrode as claimed in claim 1, wherein at least one second embedded portion is formed at each of the upper and lower sides of the skirt portion.

3. The electrode as claimed in claim 1, wherein at least two first embedded portions are formed at each of the upper and lower sides of the end portion of the skirt portion.

4. The electrode as claimed in claim 1, wherein a hole is formed in a portion of the first embedded portion which is embedded in the bead glass.

5. The electrode as claimed in claim 1, wherein an opening is formed in a portion of the first embedded portion which is embedded in the bead glass.

6. The electrode as claimed in claim 1, wherein a protrusion is formed at a portion of the first embedded portion which is embedded in the bead glass.

7. The electrode as claimed in claim 1, wherein a hole is formed in a portion of the second embedded portion which is embedded in the bead glass.

8. The electrode as claimed in claim 1, wherein an opening is formed in a portion of the second embedded portion which is embedded in the bead glass.

9. The electrode as claimed in claim 1, wherein a protrusion is formed at a portion of the second embedded portion which is embedded in the bead glass.

10. The electrode as claimed in claim 1, wherein the width of the skirt is equal to or more than 4.5 mm.
